(19) United States
(12) Patent Application Publication
(10) Pub. No.: US 2025/0355510 A1
(43) Pub. Date: Nov. 20, 2025

(54) CONTROLLER DEVICE AND METHOD FOR TRACKING CONTROLLER DEVICE USING A WEARABLE ELECTRONIC DEVICE

(71) Applicant: Samsung Electronics Co., Ltd., Suwon-si (KR)

(72) Inventors: Yongsik NAM, Suwon-si (KR); Younhyoung KIM, Suwon-si (KR); Kiwon KIM, Suwon-si (KR); Sujin PARK, Suwon-si (KR); Jin SAGONG, Suwon-si (KR)

(21) Appl. No.: 19/287,714

(22) Filed: Jul. 31, 2025

Related U.S. Application Data
(63) Continuation of application No. PCT/KR2024/001079, filed on Jan. 23, 2024.

(30) Foreign Application Priority Data
Feb. 10, 2023 (KR) 10-2023-0018071
Jun. 7, 2023 (KR) 10-2023-0073045

(51) Int. Cl. G06F 3/0346; G06F 3/03; G06F 3/038

(52) U.S. Cl. CPC G06F 3/0346; G06F 3/0304; G06F 3/0383; G06F 2203/0384

(57) ABSTRACT

A controller device may comprise a first housing and a second housing coupled to the first housing. The second housing may include: a first surface; a second surface extending from the first surface in a first direction and having a first length and at least partially surrounding the outside of the first surface; a third surface extending from one side surface of the second surface in a second direction different from the first direction, and in parallel to the first surface; a fourth surface extending from one side surface of the third surface in a third direction different from the first direction and the second direction, and having a second length less than the first length; a fifth surface corresponding to an internal surface of the second surface; wherein, at least two output modules can be arranged with a set interval therebetween on at least two surfaces from among the second surface, the third surface, the fourth surface, and the fifth surface.

### CROSS-REFERENCE TO RELATED APPLICATIONS

This application is a continuation of International Application No. PCT/KR2024/001079 designating the United States, filed on Jan. 23, 2024, in the Korean Intellectual Property Receiving Office and claiming priority to Korean Patent Application Nos. 10-2023-0018071, filed on Feb. 10, 2023, and 10-2023-0073045, filed on Jun. 7, 2023, in the Korean Intellectual Property Office, the disclosures of each of which are incorporated by reference herein in their entireties.

### BACKGROUND

### Field

The disclosure relates to a controller device and a method for tracking the controller device using a wearable electronic device.

### Description of Related Art

With the recent advancement of technology, electronic devices are gradually evolving from a uniform rectangular shape to a variety of shapes. For example, such an electronic device may include a wearable electronic device that can be worn on a part of the body.

Wearable electronic devices are changing into various forms such as augmented reality (AR) glasses in the form of glasses or head mounted displays (HMDs). Such a wearable electronic device may be communicatively connected to a controller device that includes a plurality of output modules (e.g., LED output module or ultrasonic output module). For example, the controller device may be held in the user's hand, and the movement of the controller device may occur according to the user's movement. The wearable electronic device may determine the location and/or movement of the controller device according to the user's movement by receiving signals from a plurality of output modules of the controller device being communicatively connected.

The above information may be provided as related art for the purpose of assisting in understanding the disclosure. No assertion or determination is made as to whether any of the above information constitutes prior art to the disclosure.

It may be necessary to more accurately track the controller device by determining the location and/or movement of the controller device that is communicatively connected to the wearable electronic device.

### SUMMARY

Embodiments of the disclosure provide a controller that may include: a first housing and a second housing coupled with the first housing. The second housing may comprise a plurality of surfaces, and at least two of the surfaces may include at least two output modules arranged with a specified spacing between them.

A controller device according to an example embodiment of the disclosure may include: a first housing and a second housing coupled with the first housing; the second housing may include: a first surface; a second surface extending from the first surface in a first direction and having a first length and surrounding at least a portion of an outer perimeter of the first surface; a third surface extending from one side of the second surface in a second direction different from the first direction and in parallel with the first surface; a fourth surface extending from one side of the third surface in a third direction different from the first direction and the second direction and having a second length shorter than the first length; a fifth surface corresponding to the inner surface of the second surface; wherein the controller further includes at least two output modules, comprising circuitry, arranged at a specified interval on at least two surfaces among the second surface, the third surface, the fourth surface, and the fifth surface.

A wearable electronic device according to an example embodiment of the disclosure may include: a receive module comprising circuitry, a camera, and at least one processor, comprising processing circuitry, operably connected to the receive module and the camera wherein at least one processor, individually and/or collectively, may be configured to cause the wearable electronic device to: receive signals output from a plurality of output modules of a controller device through the receive module; identify the location of the controller device using the camera; determine the distance to the controller device based on the signal received from the controller device; generate a coordinate system for each of the wearable electronic device and the controller device using the distance and sensor data of each of the wearable electronic device and the controller device; and track the movement of the controller device based on the generated coordinate system for each of the wearable electronic device and the controller device.

A method of operating the wearable electronic device to track the controller device according to an example embodiment of the disclosure may include: receiving signals output from a plurality of output modules of the controller device through a receive module; identifying the location of the controller device using a camera; determining the distance to the controller device based on signals received from the controller device; generating a coordinate system for each of the wearable electronic device and the controller device using the distance and sensor data of each of the wearable electronic device and the controller device; and tracking the movement of the controller device based on the generated coordinate systems.

According to an example embodiment of the disclosure, a non-transitory computer-readable storage medium (or, computer program product) storing one or more programs may include instructions that, when executed by at least one processor, comprising processing circuitry, individually and/or collectively, of a wearable electronic device, cause the wearable electronic device to: receive signals output from a plurality of output modules of the controller device through a receive module; identify the location of the controller device using a camera; determine the distance to the controller device based on signals received from the controller device; generate a coordinate system for each of the wearable electronic device and the controller device using the determined distance and sensor data of each of the wearable electronic device and the controller device; and track the movement of the controller device based on the generated coordinate systems.

The wearable electronic device according to various example embodiments of the disclosure may receive signals output from at least two output modules arranged at a specified interval on at least two surfaces among a plurality of surfaces of the second housing of the controller device, thereby more accurately track the movement (e.g., up/down/left/right/rotation) of the controller device. As the movement of the controller device can be tracked more accurately, the wearable electronic device may more accurately perform functions related to the content displayed on the display thereof.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example communication connection between a wearable electronic device and a controller device according to various embodiments;

FIG. 3 is a block diagram illustrating an example configuration of a wearable electronic device according to various embodiments;

FIG. 4 is a block diagram illustrating an example configuration of a controller device according to various embodiments;

FIG. 5 is a diagram illustrating a first controller device according to various embodiments;

FIG. 6 is a diagram illustrating a first controller device according to various embodiments;

FIG. 7 is a diagram illustrating a first controller device according to various embodiments; and

FIG. 8 is a flowchart illustrating an example method for tracking movement of the controller device using the wearable electronic device according to various embodiments.

### DETAILED DESCRIPTION

Hereinafter, with reference to the drawings, various example embodiments of the disclosure will be described in greater detail. However, the disclosure may be implemented in various different forms and is not limited to the various embodiments described herein. In connection with the description of the drawings, the same or similar reference symbols may be used for identical or similar components. Additionally, in the drawings and related descriptions, descriptions of well-known functions and configurations may be omitted for clarity and brevity.

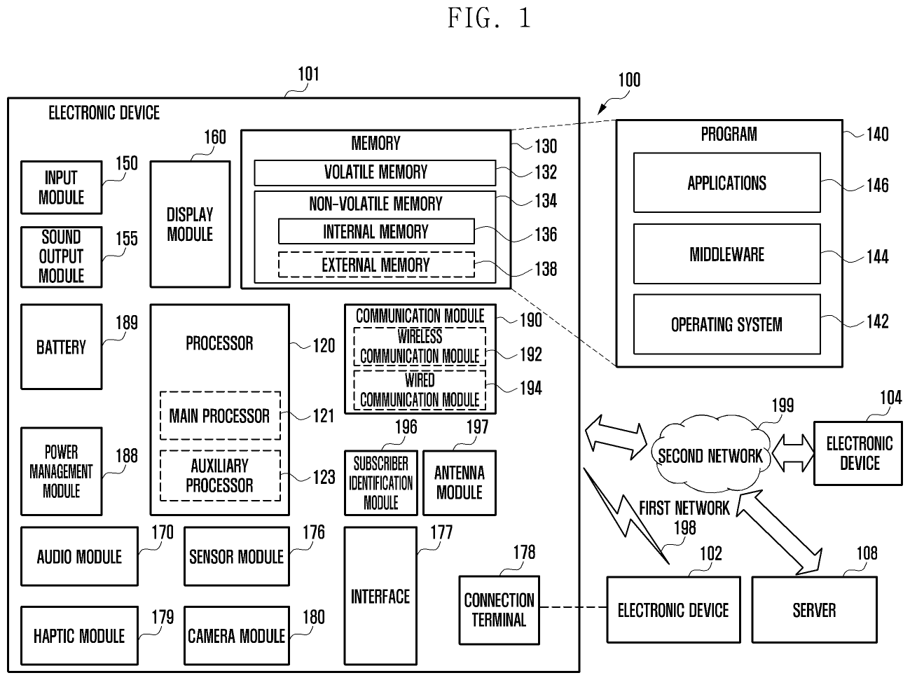

FIG. 1 is a block diagram illustrating an example electronic device 101 in a network environment 100 according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In various embodiments, at least one of the components (e.g., the connection terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include an internal memory 136 and/or an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through wires) or wirelessly. According to an embodiment, the interface 177 may include, for example, a high-definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., an application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, Wi-Fi direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., an mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

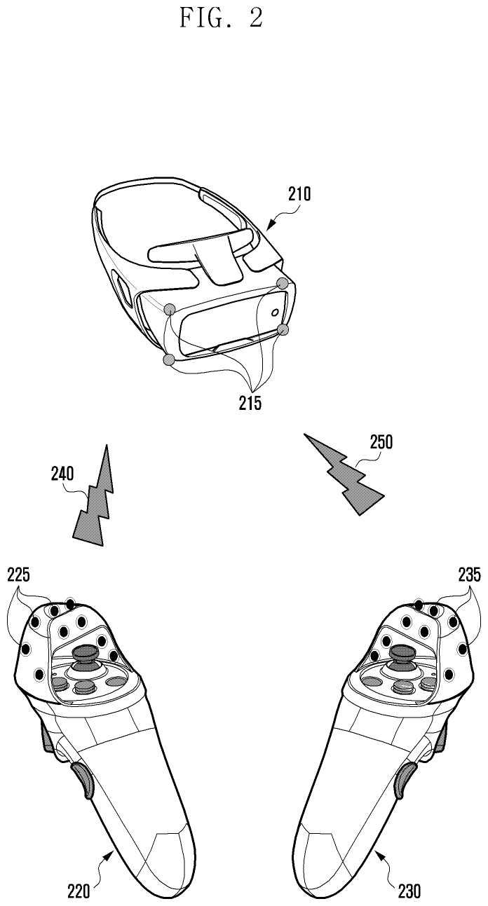

FIG. 2 is a diagram illustrating an example communication connection between a wearable electronic device 210 and controller devices 220 and 230 according to various embodiments.

With reference to FIG. 2, the wearable electronic device 210 may be communicatively connected with at least one of the controller devices 220 and 230. For example, the wearable electronic device 210 and at least one controller device 220 and/or 230 may be communicatively connected to each other (240, 250) via short-range communication (e.g., Bluetooth, BLE (Bluetooth low energy), Wi-Fi, Wi-Fi direct, Wi-Fi aware, or UWB (ultra wide band)).

In an embodiment, the wearable electronic device 210 may include augmented reality (AR) glasses or smart glasses in the form of glasses that can be worn on a part of the body, a head mounted display (HMD), or a video see-through (VST) device.

In an embodiment, the controller devices 220 and 230 may be configured in multiple instances. For example, the controller devices 220 and 230 may include a first controller device 220 and a second controller device 230. The first controller device 220 and the second controller device 230 may be configured as one set.

In an embodiment, the first controller device 220 and the second controller device 230 may be manufactured in a hand-held shape on the left and right sides. For example, the first controller device 220 may be gripped (or held) by the user's left hand and controlled (or manipulated) by the user's left hand. The second controller device 230 may be gripped (or held) by the user's right hand and controlled (or manipulated) by the user's right hand.

Without being limited thereto, the first controller device 220 and the second controller device 230 may be mounted, attached, or equipped on the wrist or clothing of the user of the wearable electronic device 210 and controlled (or manipulated) at the corresponding location.

In an embodiment, the controller devices 220 and 230 may include a plurality of output modules 225 and 235. For example, the plurality of output modules 225 and 235 may include, but not limited to, a light-emitting diode (LED) output module or an ultrasonic output module.

In an embodiment, the wearable electronic device 210 may include a plurality of receive modules 215 that receive signals (e.g., optical signals or ultrasonic signals) output from the plural output modules 225 and 235 of the controller devices 220 and 230.

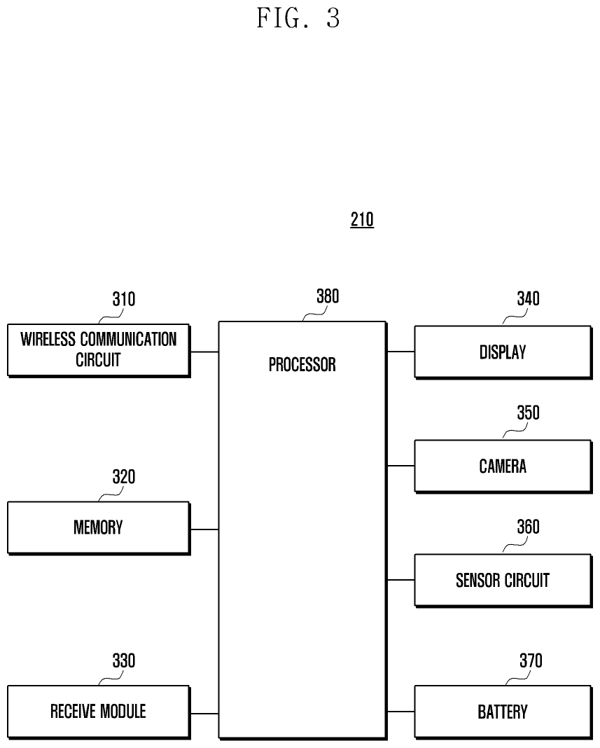

In an embodiment, the wearable electronic device 210 may track the movement of the controller devices 220 and 230 based at least in part on signals output from the plural output modules 225 and 235 of the controller devices 220 and 230 to which the communication connection is made. The wearable electronic device 210 may perform functions related to the content displayed on the display thereof (e.g., display module 160 in FIG. 1, display 340 in FIG. 3) based on the tracking of the movement of the controller devices 220 and 230.

FIG. 3 is a block diagram illustrating an example configuration of the wearable electronic device 210 according to various embodiments.

With reference to FIG. 3, the wearable electronic device 210 (e.g., electronic device 101 in FIG. 1) may include a wireless communication circuit 310 (e.g., communication module 190 in FIG. 1), a memory 320 (e.g., memory 130 in FIG. 1), a receive module (e.g., including circuitry) 330 (e.g., receive module 215 in FIG. 2), a display 340 (e.g., display module 160 in FIG. 1), a camera 350 (e.g., camera module 180 in FIG. 1), a sensor circuit 360 (e.g., sensor module 176 in FIG. 1), a battery 370 (e.g., battery 189 in FIG. 1), and/or a processor (e.g., including processing circuitry) 380 (e.g., processor 120 in FIG. 1).

According to an embodiment of the disclosure, the wireless communication circuit 310 (e.g., communication module 190 in FIG. 1) may establish a communication channel with an external electronic device (e.g., first controller device 220 and/or second controller device 230 in FIG. 2) and support transmitting and receiving various data to and from the external electronic device.

According to an embodiment of the disclosure, the memory 320 (e.g., memory 130 in FIG. 1) may store programs (e.g., programs 140 in FIG. 1) for processing and controlling the processor 380 of the wearable electronic device 210, an operating system (OS) (e.g., operating system 142 in FIG. 1), various applications (e.g., applications 146 in FIG. 1), and/or input/output data, and may store a program that controls the overall operation of the wearable electronic device 210. The memory 320 may store various instructions that can be executed by the processor 380.

In an embodiment, the memory 320 may store instructions for checking the image of the controller device 220 or 230 received through the camera 350 to identify the location of the controller device 220 or 230. The memory 320 may store instructions for measuring the distance to the controller device 220 or 230 based on a signal (e.g., optical signal or ultrasonic signal) received from the controller device 220 or 230. The memory 320 may store instructions for obtaining sensor data related to the movement of the wearable electronic device 210 through the sensor circuit 360. The memory 320 may store instructions for generating a coordinate system of the wearable electronic device 210 and the controller device 220 or 230 using the distance between the wearable electronic device 210 and the controller device 220 and 230, sensor data related to the movement of the wearable electronic device 210, and sensor data related to the movement of the controller device 220 or 230. The memory 320 may store instructions for tracking the movement of the controller device 220 or 230 based on the generated coordinate system.

According to an embodiment of the disclosure, the receive module 330 (e.g., receive module 215 in FIG. 2) may include various circuitry and receive signals (e.g., optical signal or ultrasonic signal) output from the plural output modules 225 and 235 of the controller devices 220 and 230.

According to an embodiment of the disclosure, the display 340 (e.g., display module 160 in FIG. 1) may include a first display (not shown) and/or a second display (not shown). For example, the first display (not shown) may be positioned in front of the user's left eye, and the second display (not shown) may be positioned in front of the user's right eye. Hence, the first display (not shown) and/or the second display (not shown) may display various information, which is transmitted to the user's left eye and/or right eye.

According to an embodiment of the disclosure, the camera 350 (e.g., camera module 180 in FIG. 1) may capture the front of the user (e.g., user of the wearable electronic device 210) to obtain image data. The camera 350 may capture an image corresponding to the user's field of view (FoV) or measure the distance to a subject (e.g., object) and/or the controller device 220 or 230. The camera 350 may include an RGB camera, a high resolution (HR) camera, and/or a photo video (PV) camera. The camera 350 may include a color camera having an auto focus (AF) function and an optical image stabilization (OIS) function to obtain high-quality images.

According to an embodiment of the disclosure, the sensor circuit 360 (e.g., sensor module 176 in FIG. 1) may include a motion sensor (not shown) (e.g., acceleration sensor, gyro sensor, and/or magnetic field sensor) for detecting movement (e.g., up/down/left/right head movement) of the wearable electronic device 210 (or, the user).

In an embodiment, the sensor circuit 360 may include a position sensor (not shown) (e.g., global navigation satellite system (GNSS)) for detecting location information (e.g., coordinate information) of the wearable electronic device 210.

In an embodiment, the sensor circuit 360 may transfer, to the processor 380, information about movement of the wearable electronic device 210 obtained through the motion sensor and/or location information of the wearable electronic device 210 obtained through the position sensor.

According to an embodiment of the present disclosure, the battery 370 (e.g., battery 189 in FIG. 1) may supply power to a plurality of hardware components using a power management module (e.g., power management module 188 in FIG. 1). The battery 370 may include, for example, a non-rechargeable primary cell, a rechargeable secondary cell, or a fuel cell.

According to an embodiment of the disclosure, the processor 380 (e.g., processor 120 in FIG. 1) may include, for example, various processing circuitry, including a micro controller unit (MCU), and may execute the operating system (OS) or an embedded software program to control a plurality of hardware components connected to the processor 380. The processor 380 may control a plurality of hardware components according to, for example, instructions (e.g., programs 140 in FIG. 1) stored in the memory 320. The description of the processor 120 above, applies equally to the processor 380, and thus a detailed description of the processor may not be repeated here.

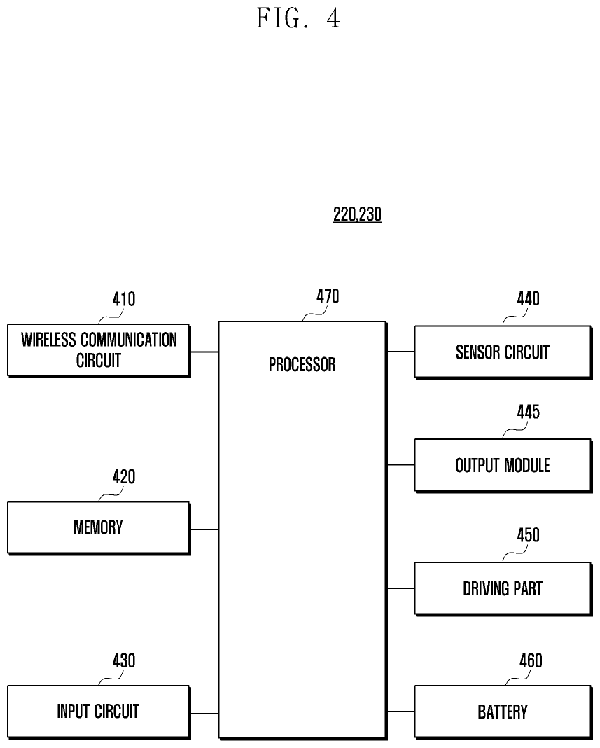

In an embodiment, the processor 380 may receive signals (e.g., optical signal or ultrasonic signal) output from the plurality of output modules (e.g., output modules 445 in FIG. 4) (e.g., LED output module or ultrasonic output module) of the controller devices 220 and 230 through the receive module 330. The processor 380 may use the camera 350 to identify the location of the controller device 220 or 230. For example, the processor 380 may check the image of the controller device 220 or 230 received through the camera 350 to identify the location of the controller device 220 or 230. The processor 380 may measure (e.g., determine, identify) the distance to the controller device 220 or 230 based on a signal (e.g., optical signal or ultrasonic signal) received from the controller device 220 or 230. The processor 380 may generate coordinate systems of the wearable electronic device 210 and the controller device 220 or 230 using the distance between the wearable electronic device 210 and the controller device 220 or 230, the first sensor data related to the movement of the wearable electronic device 210, and the second sensor data related to the movement of the controller device 220 or 230. For example, the processor 380 may generate a first coordinate system related to the location of the wearable electronic device 210, a second coordinate system related to the location of a controller device, for example, the first controller device 220, and a third coordinate system related to the location of the second controller device 230. The processor 380 may track the movement of the controller device 220 or 230 based on the generated coordinate systems. The processor 380 may perform a function related to the content displayed on the display 340 based on tracking the movement of the first controller device 220 and the movement of the second controller device 230.

The wearable electronic device 210 according to an embodiment of the disclosure may include a receive module 330, a camera 350, and a processor 380 operably connected to the receive module 330 and the camera 350. In an embodiment, the processor 380 may receive signals output from the plurality of output modules (e.g., output modules 541, 543, 545 and 547) of the controller devices 220 and 230 through the receive module 330. In an embodiment, the processor 380 may identify the location of the controller device 220 or 230 using the camera 350. In an embodiment, the processor 380 may measure (e.g., determine, identify) the distance to the controller device 220 or 230 based on the signal received from the controller device 220 or 230. In an embodiment, the processor 380 may generate a coordinate system for each of the wearable electronic device 210 and the controller devices 220 and 230 using the measured distance between the wearable electronic device 210 and the controller device 220 or 230 and the sensor data of each of the wearable electronic device 210 and the controller devices 220 and 230. In an embodiment, the processor 380 may track the movement of the controller device 220 or 230 based on the generated coordinate systems of the wearable electronic device 210 and the controller device 220 or 230.

In an embodiment, the processor 380 may receive signals output from the plurality of output modules 541, 543, 545 and 547 of the controller devices 220 and 230 at a specified periodicity.

The wearable electronic device 210 according to an embodiment may further include a wireless communication circuit 310 and a sensor circuit 360.

In an embodiment, the sensor data of each of the wearable electronic device 210 and the controller devices 220 and 230 may include first sensor data related to the movement of the wearable electronic device 210 obtained through the sensor circuit 360, and second sensor data related to the movement of the controller devices 220 and 230 received from the controller devices 220 and 230 through the wireless communication circuit 310.

In an embodiment, the processor 380 may track the movement of each of the controller devices 220 and 230 according to the coordinate system associated with the location of each of the controller devices 220 and 230 with respect to the coordinate system associated with the location of the wearable electronic device 210.

The wearable electronic device 210 according to an embodiment may further include a display 340. In an embodiment, the processor 380 may perform functions related to the content displayed on the display 340 based on tracking the movement of the controller devices 220 and 230.

FIG. 4 is a block diagram illustrating an example configuration of a controller device 220 or 230 according to various embodiments.

With reference to FIG. 4, the controller device 220 or 230 (e.g., electronic device 101 in FIG. 1) may include a wireless communication circuit 410 (e.g., communication module 190 in FIG. 1), a memory 420 (e.g., memory 130 in FIG. 1), an input circuit 430 (e.g., input module 150 in FIG. 1), a sensor circuit 440 (e.g., sensor module 176 in FIG. 1), an output module (e.g., including circuitry) 445, a driving part (e.g., including circuitry) 450, a battery 460 (e.g., battery 189 in FIG. 1), and/or a processor (e.g., including processing circuitry) 470 (e.g., processor 120 in FIG. 1).

According to an embodiment of the disclosure, the wireless communication circuit 410 (e.g., communication module 190 in FIG. 1) may establish a communication channel with an external electronic device (e.g., wearable electronic device 210 in FIG. 2) and support transmitting and receiving various signals (or data) to and from the external electronic device.

In an embodiment, the controller device 220 or 230 may transmit an input signal detected by the input circuit 430 and/or sensor data related to movement of the controller device 220 or 230 through the wireless communication circuit 410 to the wearable electronic device 210.

According to an embodiment of the disclosure, the memory 420 (e.g., memory 130 in FIG. 1) may store a program (e.g., program 140 in FIG. 1) for processing and controlling the processor 470 of the controller device 220 or 230, an operating system (OS) (e.g., operating system 142 in FIG. 1), various applications (e.g., applications 146 in FIG. 1), and/or input/output data, and may store a program for controlling the overall operation of the controller device 220 or 230. The memory 420 may store various instructions that can be executed by the processor 470.

In an embodiment, the memory 420 may store instructions for controlling the driving part 450 to cause the output module 445 to output a signal (e.g., optical signal or ultrasonic signal) at a specified interval (or, in a specified pattern). The memory 420 may store instructions for obtaining sensor data related to the movement of the controller device 220 or 230 through the sensor circuit 440 and transmitting the sensor data to the wearable electronic device 210.

According to an embodiment of the disclosure, the input circuit 430 (e.g., input module 150 in FIG. 1) may receive a command or data to be used for a component (e.g., processor 470) of the controller device 220 or 230 from the outside of the controller device 220 or 230 (e.g., user).

In an embodiment, the input circuit 430 may include, for example, a plurality of buttons and/or a joystick. The input circuit 430 may detect an input signal generated from the plural buttons and/or joystick.

According to an embodiment of the disclosure, the sensor circuit 440 (e.g., sensor module 176 in FIG. 1) may include a motion sensor (not shown) (e.g., acceleration sensor, gyro sensor, and/or magnetic field sensor) for sensing the movement (e.g., up/down/left/right movement) of the controller device 220 or 230 (or, the user).

In an embodiment, the sensor circuit 440 may transfer sensor data related to the movement of the controller device 220 or 230 obtained through the motion sensor to the processor 470.

According to an embodiment of the disclosure, the output module 445 may include an LED output module or an ultrasonic output module. In an embodiment, the output module 445 may output a signal (e.g., optical signal or ultrasonic signal) at a specified interval (or, in a specified pattern).

According to an embodiment of the disclosure, the driving part 450 may control the driving of the output module 445 so that the output module 445 outputs a signal (e.g., optical signal or ultrasonic signal) at a specified interval (or, in a specified pattern).

According to an embodiment of the disclosure, the battery 460 (e.g., battery 189 in FIG. 1) may supply power to a plurality of hardware components using a power management module (e.g., power management module 188 in FIG. 1). The battery 460 may include, for example, a non-rechargeable primary cell, a rechargeable secondary cell, or a fuel cell.

According to an embodiment of the disclosure, the processor 470 (e.g., processor 120 in FIG. 1) may include various processing circuitry, for example, a micro controller unit (MCU), and may execute the operating system (OS) or an embedded software program to control a plurality of hardware components connected to the processor 470. The processor 470 may control a plurality of hardware components according to, for example, instructions stored in the memory 420 (e.g., programs 140 in FIG. 1). The description of the processor 120 above, applies equally to the processor 470, and thus a detailed description of the processor may not be repeated here.

In an embodiment, the processor 470 may control the driving part 450 to cause the output module 445 to output a signal (e.g., optical signal or ultrasonic signal) at a specified interval (or, in a specified pattern).

In an embodiment, the processor 470 may transfer an input signal detected by the input circuit 430 and/or sensor data related to the movement of the controller device 220 or 230 through the wireless communication circuit 410 to the wearable electronic device 210.

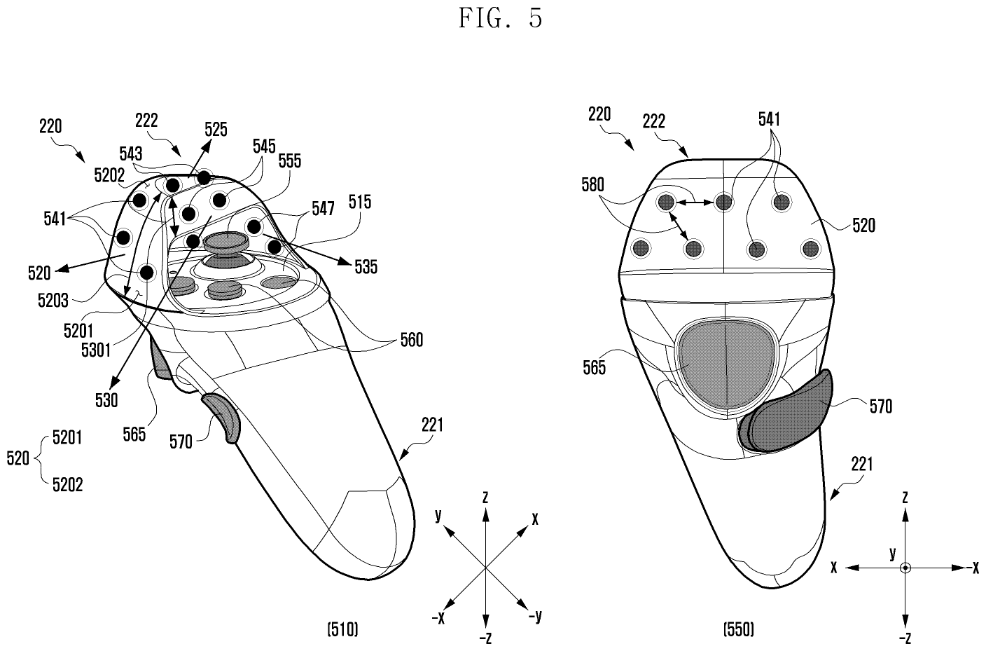

FIG. 5 is a diagram illustrating various views of the first controller device 220 according to various embodiments.

FIG. 5 is a schematic perspective view of the first controller device 220 communicatively connected to the wearable electronic device (e.g., wearable electronic device 210 of FIG. 2) according to an embodiment of the disclosure.

Indicia <510> in FIG. 5 according to various embodiments indicates a drawing of the first controller device 220 viewed from one side, and indicia <550> indicates a drawing of the first controller device 220 viewed from the front.

In an embodiment, the first controller device 220 may perform a function related to the content (e.g., game content) displayed through the display (e.g., display 340 in FIG. 3) of the wearable electronic device 210. For example, the first controller device 220 may be a handler capable of controlling the content displayed on the display 340 of the wearable electronic device 210.

With reference to FIG. 5, the first controller device 220 may include a first housing 221 and a second housing 222 coupled with the first housing 221. In an embodiment, the first housing 221 and the second housing 222 may be connected as a single body.

In an embodiment, a plurality of buttons may be arranged on the first housing 221. For example, the plurality of buttons may include a first button 565 and/or a second button 570. The first button 565 (e.g., trigger button) and/or the second button 570 (e.g., grip button) may be a button capable of controlling the content displayed on the display 340 of the wearable electronic device 210.

In various embodiments, the components arranged on the first housing 221 are not limited to those components described above, and various other components may be arranged thereon.

In an embodiment, a plurality of output modules (e.g., output module 445 in FIG. 4) may be arranged on the second housing 222. For example, the plurality of output modules may include, but not limited to, an LED output module or an ultrasonic output module.

In an embodiment, the plurality of output modules may be arranged in a specified pattern on the second housing 222 at a specified interval 580 (e.g., about 25 mm).

In an embodiment, the second housing 222 may include a plurality of surfaces. For example, the plurality of surfaces may include a first surface 515, a second surface 520, a third surface 525, a fourth surface 530, and/or a fifth surface 535.

In an embodiment, at least two output modules may be arranged on at least two surfaces among the second surface 520, the third surface 525, the fourth surface 530, and/or the fifth surface 535 of the second housing 222.

In an embodiment, the first surface 515 of the second housing 222 may be formed as a flat surface. In an embodiment, the joystick 555 and/or the third button 560 may be disposed on the first surface 515 of the second housing 222. The joystick 555 and/or the third button 560 may be a button for controlling the content displayed on the display 340 of the wearable electronic device 210.

In an embodiment, the second surface 520 of the second housing 222 may be formed to extend from at least a portion of the outer perimeter of the first surface 515 to have a first length 5203 in a first direction (e.g., z-axis direction) while surrounding the at least a portion of the outer perimeter of the first surface 515.

In an embodiment, the second surface 520 of the second housing 222 may include a first region 5201 and a second region 5202. For example, the first region 5201 of the second surface 520 may be a region formed to extend flatly in the first direction (e.g., z-axis direction) from at least a portion of the outer perimeter of the first surface 515. The second region 5202 of the second surface 520 may be formed in a curved shape having a specified curvature. For example, the second region 5202 of the second surface 520 may be a region formed to be curved from the first region 5201 toward the third surface 525 of the second housing 222.

In an embodiment, at least two output modules 541 may be arranged on the second surface 520 of the second housing 222 at a specified interval 580 (e.g., about 25 mm).

In an embodiment, the third surface 525 of the second housing 222 may be formed to extend from one side of the second surface 520 in a second direction (e.g., x-y axis direction) and be substantially parallel to the first surface 515.

In an embodiment, the third surface 525 formed substantially parallel to the first surface 515 of the second housing 222 may be formed to extend from one side of the second surface 520 in the second direction (e.g., x-y axis direction) with a length shorter than the diameter of the first surface 515. Hence, the third surface 525 of the second housing 222 may be formed to cover at least a portion of the first surface 515 in a state of being spaced apart from the first surface 515.

In an embodiment, at least two output modules 543 may be arranged on the third surface 525 of the second housing 222 at a specified interval 580 (e.g., about 25 mm).

In an embodiment, the fourth surface 530 of the second housing 222 may be formed to extend from one side of the third surface 525 of the second housing 222 in a third direction (e.g., negative z-axis direction). The fourth surface 530 of the second housing 222 may have a second length 5301 shorter than the first length 5203 of the second surface 520 formed in the first direction (e.g., z-axis direction).

In an embodiment, at least two output modules 545 may be arranged on the fourth surface 530 of the second housing 222 at a specified interval 580 (e.g., about 25 mm).

In an embodiment, the fifth surface 535 of the second housing 222 may be formed to extend in the second direction (e.g., x-y axis direction) from one side of the second surface 520 of the second housing 222. For example, the fifth surface 535 of the second housing 222 may correspond to the inner surface of the second surface 520 of the second housing 222, without being limited thereto.

In an embodiment, at least two output modules 547 may be arranged on the fifth surface 535 of the second housing 222 at a specified interval 580 (e.g., about 25 mm).

In an embodiment, the plurality of output modules 541, 543, 545 and 547 may output signals (e.g., optical signal or ultrasonic signal) at a specified periodicity (or, in a specified pattern).

According to various embodiments, the first controller device 220 may include a printed circuit board (not shown) disposed inside the first housing 221. Electronic components that perform substantially the same functions as the wireless communication circuit 410, memory 420, input circuit 430, sensor circuit 440, driving part 450, and/or processor 470 illustrated in FIG. 4 may be arranged on the printed circuit board (not shown) of the first controller device 220.

In FIG. 5 according to various embodiments, only the first controller device 220 is illustrated, but the second controller device (e.g., second controller device 230 in FIG. 2) may include substantially the same components as the first controller device 220 of FIG. 5 and may also perform substantially the same functions.

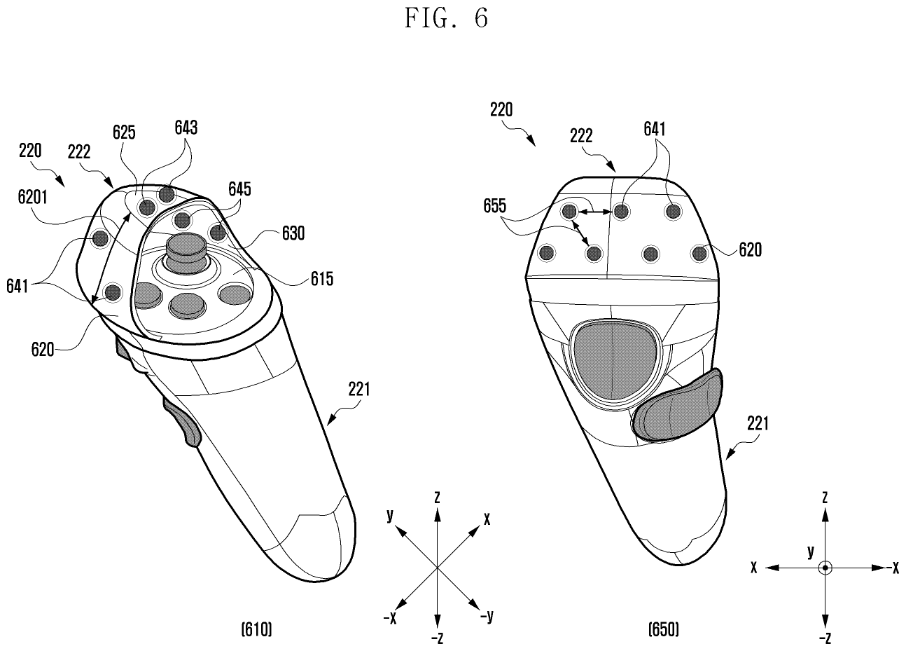

FIG. 6 is a diagram illustrating various views of the first controller device 220 according to various embodiments.

In comparison to the first controller device 220 shown in FIG. 5 described above, the first controller device 220 shown in FIG. 6 according to various embodiments may have a structure in which the fourth surface 530 of the second housing 222 is omitted (or, removed).

Except that the fourth surface 530 of the second housing 222 described above is omitted (or removed) according to various embodiments, the structure of the first controller device 220 of FIG. 6 is the same as or similar to the structure of the first controller device 220 of FIG. 5 described above, so for the same configuration as the first controller device 220 shown in FIG. 5, reference may be made to the description related to FIG. 5. In the following description of FIG. 6, the configurations that are different from FIG. 5 will be described.

Indicia <610> of FIG. 6 according to various embodiments indicates a drawing of the first controller device 220 viewed from one side, and indicia <650> indicates a drawing of the first controller device 220 viewed from the front.

With reference to FIG. 6, the first controller device 220 may include a first housing 221 and a second housing 222 coupled with the first housing 221.

In an embodiment, a plurality of output modules (e.g., output module 445 in FIG. 4) may be arranged in the second housing 222 at a specified interval 655 (e.g., about 25 mm). For example, the plurality of output modules may include, but not limited to, an LED output module or an ultrasonic output module.

In an embodiment, the second housing 222 may be include a plurality of surfaces, for example, a first surface 615 (e.g., first surface 515 in FIG. 5), a second surface 620 (e.g., second surface 520 in FIG. 5), a third surface 625 (e.g., third surface 525 in FIG. 5), and/or a fourth surface 630 (e.g., fifth surface 535 in FIG. 5).

In an embodiment, the first surface 615 of the second housing 222 may be formed as a flat surface.

In an embodiment, the second surface 620 of the second housing 222 may be formed to extend from at least a portion of the outer perimeter of the first surface 615 to have a first length 6201 (e.g., first length 5203 in FIG. 5) in a first direction (e.g., z-axis direction) while surrounding the at least a portion of the outer perimeter of the first surface 615. In an embodiment, at least two output modules 641 may be arranged on the second surface 620 of the second housing 222 at a specified interval 655 (e.g., about 25 mm).

In an embodiment, the third surface 625 of the second housing 222 may be formed to extend from one side of the second surface 620 in a second direction (e.g., x-y axis direction) and be parallel to the first surface 615. In an embodiment, at least two output modules 643 may be arranged on the third surface 625 of the second housing 222 at a specified interval 655 (e.g., about 25 mm).

In an embodiment, the fourth surface 630 of the second housing 222 may correspond to the inner surface of the second surface 620 of the second housing 222. In an embodiment, at least two output modules 645 may be arranged on the fourth surface 630 of the second housing 222 at a specified interval 655 (e.g., about 25 mm).

In FIG. 6 according to various embodiments, only the first controller device 220 is illustrated, but the second controller device (e.g., second controller device 230 in FIG. 2) may include substantially the same components as the first controller device 220 of FIG. 6 and may also perform substantially the same functions.

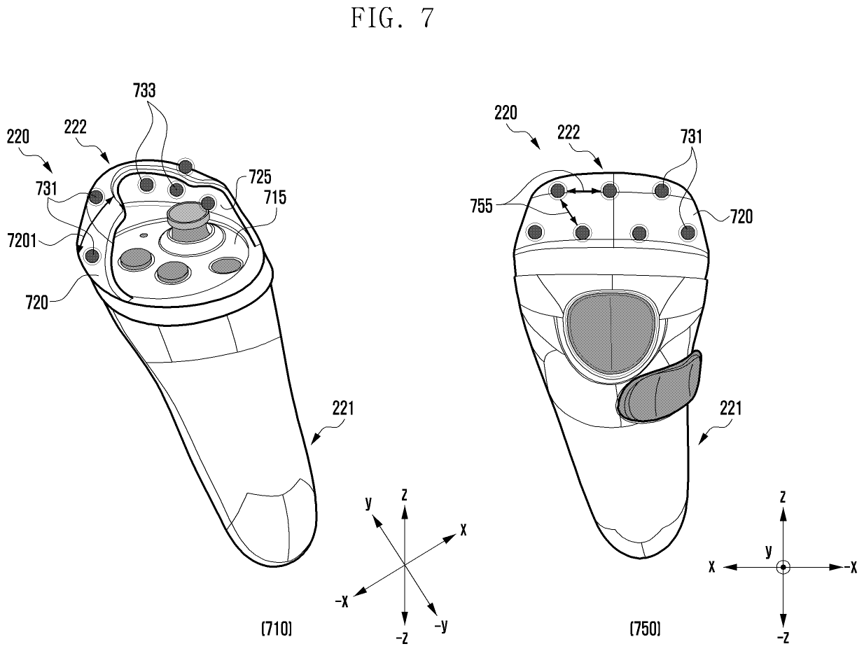

FIG. 7 is a diagram illustrating various views of the first controller device 220 according to various embodiments.

In comparison to the first controller device 220 shown in FIG. 5 described above, the first controller device 220 shown in FIG. 7 according to various embodiments may have a structure in which the third surface 525 and the fourth surface 530 of the second housing 222 are omitted (or, removed).

Except that the third surface 525 and the fourth surface 530 of the second housing 222 described above are omitted (or removed) according to various embodiments, the structure of the first controller device 220 of FIG. 7 is the same as or similar to the structure of the first controller device 220 of FIG. 5 described above, so for the same configuration as the first controller device 220 shown in FIG. 5, reference may be made to the description related to FIG. 5. In the following description of FIG. 7, the configurations that are different from FIG. 5 will be described.

Indicia <710> of FIG. 7 according to various embodiments indicates a drawing of the first controller device 220 viewed from one side, and indicia <750> indicates a drawing of the first controller device 220 viewed from the front.

With reference to FIG. 7, the first controller device 220 may include a first housing 221 and a second housing 222 coupled with the first housing 221.

In an embodiment, the second housing 222 may include a plurality of surfaces, for example, a first surface 715 (e.g., first surface 515 in FIG. 5, first surface 615 in FIG. 6), a second surface 720 (e.g., second surface 520 in FIG. 5, second surface 620 in FIG. 6), and a third surface 725 (e.g., fifth surface 535 in FIG. 5, fourth surface 630 in FIG. 6).

In an embodiment, the first surface 715 of the second housing 222 may be formed as a flat surface.

In an embodiment, the second surface 720 of the second housing 222 may be formed to extend from at least a portion of the outer perimeter of the first surface 715 to have a first length 7201 (e.g., first length 5203 in FIG. 5, first length 6201 in FIG. 6) in a first direction (e.g., z-axis direction) while surrounding the at least a portion of the outer perimeter of the first surface 715.

In an embodiment, the third surface 725 of the second housing 222 may correspond to the inner surface of the second surface 720 of the second housing 222.

In an embodiment, at least two output modules may be arranged on at least one surface, among the second surface 720 and the third surface 725 of the second housing 222, at a specified interval 755 (e.g., about 25 mm). For example, at least two output modules 731 may be arranged on the second surface 720 of the second housing 222 at a specified interval 755 (e.g., about 25 mm). At least two output modules 733 may be arranged on the third surface 725 of the second housing 222 at a specified interval 755 (e.g., about 25 mm).

In FIG. 7 according to various embodiments, only the first controller device 220 is illustrated, but the second controller device (e.g., second controller device 230 in FIG. 2) may include substantially the same components as the first controller device 220 of FIG. 7 and may also perform substantially the same functions.

As illustrated in FIGS. 5, 6 and 7 (which may be referred to as FIGS. 5 to 7) according to various embodiments, the controller device 220 or 230 may include at least two output modules arranged at a specified interval on at least two surfaces among a plurality of surfaces of the second housing 222. Since at least two output modules are arranged on at least two surfaces of the second housing 222, even if the controller device 220 or 230 is moved (e.g., movement related to up/down/left/right/rotation), signals (e.g., optical signal or ultrasonic signal) output from the at least two output modules arranged on the at least two surfaces can be received, so that the movement of the controller device 220 or 230 can be tracked more accurately. As the movement of the controller device 220 or 230 can be tracked more accurately, functions related to the content displayed on the display 340 of the wearable electronic device 210 can be performed more accurately.

The controller device 220 or 230 according to an embodiment of the disclosure may include a first housing 221 and a second housing 222 coupled with the first housing 221. In an embodiment, the second housing 222 may include a first surface 515. In an embodiment, the second housing 222 may include a second surface 520 that is formed to be extended from the first surface 515 of the second housing 222 in a first direction to have a first length 5203 and to surround at least a portion of the outer perimeter of the first surface 515. In an embodiment, the second housing 222 may include a third surface 525 that is formed to be extended from one side of the second surface 520 of the second housing 222 in a second direction different from the first direction and to be in parallel with the first surface 515. In an embodiment, the second housing 222 may include a fourth surface 530 that is formed to be extended from one side of the third surface 525 of the second housing 222 in a third direction different from the first direction and the second direction and to have a second length 5301 shorter than the first length 5203. In an embodiment, the second housing 222 may include a fifth surface 535 corresponding to the inner surface of the second surface 520 of the second housing 222. In an embodiment, at least two output modules 541, 543, 545 and 547 may be arranged at a specified interval 580 on at least two surfaces among the second surface 520, the third surface 525, the fourth surface 530, and the fifth surface 535 of the second housing 222.

In an embodiment, the second surface 520 of the second housing 222 may include a first region 5201 and a second region 5202. In an embodiment, the first region 5201 of the second surface 520 of the second housing 222 may be a region that is formed to be extended flatly in the first direction from at least a portion of the outer perimeter of the first surface 515 of the second housing 222. In an embodiment, the second region 5202 of the second surface 520 of the second housing 222 may be a region that is formed to be curved from the first region 5201 of the second surface 520 of the second housing 222 toward the third surface 525 of the second housing 222.

In an embodiment, the third surface 525 of the second housing 222 may be formed to extend in the second direction from one side of the second surface 520 of the second housing 222 to have a length shorter than the diameter of the first surface 515 of the second housing 222.

In an embodiment, as the third surface 525 of the second housing 222 is formed to extend in the second direction from one side of the second surface 520 of the second housing 222 with a length shorter than the diameter of the first surface 515 of the second housing 222, it may be formed to cover at least a portion of the first surface 515 of the second housing 222 in a state of being spaced apart from the first surface 515 of the second housing 222.

In an embodiment, the at least two output modules 541, 543, 545 and 547 may include an LED output module or an ultrasonic output module.

The controller device 220 or 230 according to an embodiment may include a printed circuit board disposed inside the first housing 221. The controller device 220 or 230 according to an embodiment may further include a processor 470 arranged on the printed circuit board.

The controller device 220 or 230 according to an embodiment may further include a driving part 450. In an embodiment, the processor 470 may control the driving part 450 to cause the at least two output modules 541, 543, 545 and 547 to output signals at a specified periodicity.

The controller device 220 or 230 according to an embodiment may further include an input circuit 430 and a sensor circuit 440. In an embodiment, the processor 470 may detect an input signal through the input circuit 430. In an embodiment, the processor 470 may obtain sensor data related to the movement of the controller device 220 or 230 through the sensor circuit 440.

The controller device 220 or 230 according to an embodiment may further include a wireless communication circuit 410. In an embodiment, the processor 470 may transmit, via the wireless communication circuit 410 to the wearable electronic device 210, at least one of an input signal detected through the input circuit 430 or sensor data related to the movement of the controller device 220 or 230 obtained through the sensor circuit 440.

The controller device 220 or 230 according to an embodiment may be configured in a form in which the third surface 525 of the second housing (222) is removed.

The controller device 220 or 230 according to an embodiment may be configured in a form in which the third surface 525 and the fourth surface 530 of the second housing 222 are removed.

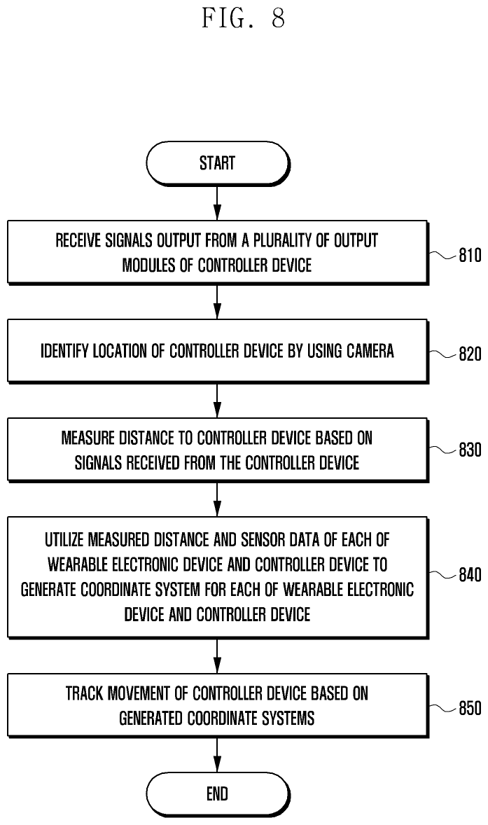

FIG. 8 is a flowchart illustrating an example method for tracking movement of the controller device 220 or 230 using the wearable electronic device 210 according to various embodiments.

In the following example, operations may be performed in sequence, but operations are not necessarily performed in sequence. For example, the order of operations may be changed, and at least two operations may be performed in parallel.

With reference to FIG. 8, in an embodiment, at operation 810, the processor (e.g., processor 380 in FIG. 3) of the wearable electronic device (e.g., wearable electronic device 210 of FIG. 2) may receive signals output from a plurality of output modules (e.g., output module 445 in FIG. 4) of the controller devices (e.g., first controller device 220 and/or second controller device 230 in FIG. 2).

In an embodiment, each of the first controller device 220 and the second controller device 230 may include a plurality of output modules. For example, as illustrated in FIGS. 5 to 7 described above, the plural output modules may be arranged at a specified interval on at least two surfaces among a plurality of surfaces (e.g., second surface 520, third surface 525, fourth surface 530, fifth surface 535 in FIG. 5; second surface 620, third surface 625, fourth surface 630 in FIG. 6; second surface 720, third surface 725 in FIG. 7) of the second housing (e.g., second housing 222 in FIG. 5) of the controller device 220 or 230.

In an embodiment, the plural output modules may include an LED output module or an ultrasonic output module. The signals received from the plural output modules may include an optical signal or an ultrasonic signal.

In an embodiment, the processor 380 may receive signals output from the plural output modules of the controller devices 220 and/or 230 through the receive module (e.g., receive module 330 in FIG. 3).

In an embodiment, at operation 820, the processor 380 may identify the location of the controller devices 220 and/or 230 using a camera (e.g., camera 350 in FIG. 3).

In an embodiment, the processor 380 may calculate the location of the controller devices 220 and/or 230 moving within the field of view of the camera 350. For example, the processor 380 may check the images of the controller devices 220 and/or 230 received through the camera 350 to identify the location of the controller devices 220 and/or 230.

In an embodiment, at operation 830, the processor 380 may measure (or determine, or identify) the distance to the controller devices 220 and/or 230 based on signals received from the controller devices 220 and/or 230. For example, the processor 380 may determine (or identify) the distance between the wearable electronic device 210 and the controller devices 220 and/or 230 with respect to the current location of the wearable electronic device 210 based on signals received from the plurality of output modules of the controller devices 220 and/or 230.

In an embodiment, at operation 840, the processor 380 may use the distance and sensor data of each of the wearable electronic device 210 and the controller devices 220 and/or 230 to generate a coordinate system of each of the wearable electronic device 210 and the controller devices 220 and/or 230.

In an embodiment, the processor 380 may obtain first sensor data related to the movement of the wearable electronic device 210 through a sensor circuit (e.g., sensor circuit 360 in FIG. 3).

In an embodiment, each controller device 220 and/or 230 may obtain second sensor data related to the movement of the controller device 220 and/or 230 via a sensor circuit (e.g., sensor circuit 440 in FIG. 4). The controller device 220 and/or 230 may transmit the obtained second sensor data to the wearable electronic device 210.

In an embodiment, the processor 380 may generate coordinate systems of the wearable electronic device 210 and the controller devices 220 and/or 230 using the distance between the wearable electronic device 210 and the controller devices 220 and/or 230, the first sensor data related to the movement of the wearable electronic device 210, and the second sensor data related to the movement of the controller devices 220 and/or 230. For example, the processor 380 may generate a first coordinate system associated with the location of the wearable electronic device 210, a second coordinate system associated with the location of a controller device, for example, the first controller device 220, and a third coordinate system associated with the location of the second controller device 230.

In an embodiment, at operation 850, the processor 380 may track the movement of the controller devices 220 and/or 230 based on the generated coordinate systems.

In an embodiment, the processor 380 may track the movement of the controller devices 220 and/or 230 based on the generated first coordinate system associated with the location of the wearable electronic device 210, the generated second coordinate system associated with the location of the first controller device 220, and the generated third coordinate system associated with the location of the second controller device 230. For example, the processor 380 may track the movement of the first controller device 220 and the movement of the second controller device 230 with respect to the first coordinate system associated with the location of the wearable electronic device 210.

In an embodiment, the movement of the controller devices 220 and/or 230 may be tracked using six degrees of freedom (6DoF). For example, 6DoF may be utilized to track, with respect to the wearable electronic device 210, translational movements (e.g., up/down, left/right, forward/backward movement) of the controller devices 220 and/or 230 along the x, y and/or z axes and/or rotational movements thereof around the above axes.

In an embodiment, although not shown, the processor 380 may perform functions related to the content displayed on the display (e.g., display 340 in FIG. 3 (e.g., first display (not shown) and second display)) based on tracking the movement of the first controller device 220 and the movement of the second controller device 230.

As described in FIGS. 5 to 7 according to various embodiments, the controller device 220 or 230 may include at least two output modules arranged at a specified interval on at least two surfaces among the plural surfaces of the second housing 222. In an embodiment, the wearable electronic device 210 may identify (or measure) the distance between the at least two output modules arranged on the at least two surfaces through the camera 350, and determine the distance to the controller device 220 or 230 based on the identified distance. For example, the wearable electronic device 210 may recognize the distance between the two output modules as shorter through the camera 350 as the distance to the controller device 220 or 230 increases. For another example, the wearable electronic device 210 may recognize the distance between the two output modules as longer through the camera 350 as the distance to the controller device 220 or 230 decreases. By utilizing the above-described features, even when the controller device 220 or 230 is moved (e.g., movement related to up/down/left/right/rotation), the wearable electronic device 210 may receive signals (e.g., optical signal or ultrasonic signal) output from at least two output modules arranged on at least two surfaces of the second housing 222 of the controller device 220 or 230, and more accurately track the movement of the controller device 220 or 230. As the movement of the controller device 220 or 230 can be tracked more accurately, functions related to the content displayed on the display 340 of the wearable electronic device 210 can be performed more accurately.

The method of operating the wearable electronic device 210 to track the controller device 220 or 230 according to an embodiment of the disclosure may include an operation of receiving signals output from a plurality of output modules 541, 543, 545 and 547 of the controller device 220 or 230 through a receive module 330. In an embodiment, the method for the wearable electronic device 210 to track the controller device 220 or 230 may include an operation of identifying the location of the controller device 220 or 230 using a camera 350. The method for the wearable electronic device 210 to track the controller device 220 or 230 may include an operation of measuring the distance to the controller device 220 or 230 based on signals received from the controller device 220 or 230. The method for the wearable electronic device 210 to track the controller device 220 or 230 may include an operation of generating a coordinate system of each of the wearable electronic device 210 and the controller device 220 or 230 using the measured distance between the wearable electronic device 210 and the controller device 220 or 230 and the sensor data of each of the wearable electronic device 210 and the controller device 220 or 230. The method for the wearable electronic device 210 to track the controller device 220 or 230 may include an operation of tracking the movement of the controller device 220 or 230 based on the generated coordinate systems of the wearable electronic device 210 and the controller device 220 or 230.

In an embodiment, the operation of receiving signals output from the plural output modules 541, 543, 545 and 547 of the controller device 220 or 230 may include an operation of receiving signals output from the plural output modules 541, 543, 545 and 547 of the controller device 220 or 230 at a specified periodicity.

In an embodiment, the operation of tracking the movement of the controller device 220 or 230 may include an operation of tracking, with respect to the coordinate system associated with the location of the wearable electronic device 210, the movement of each of the controller devices 220 and 230 according to the coordinate system associated with the location of each of the controller devices 220 and 230.

The method for the wearable electronic device 210 to track the controller device 220 or 230 according to an embodiment may further include an operation of performing a function related to the content displayed on the display 340 based on tracking the movement of the controller device 220 or 230.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., through wires), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A controller device comprising:
a first housing; and
a second housing coupled with the first housing,
wherein the second housing includes:
a first surface;
a second surface extending from the first surface in a first direction and having a first length and surrounding at least a portion of an outer perimeter of the first surface;
a third surface extending from one side of the second surface in a second direction different from the first direction and in parallel with the first surface;
a fourth surface extending from one side of the third surface in a third direction different from the first direction and the second direction and having a second length shorter than the first length; and
a fifth surface corresponding to an inner surface of the second surface,
wherein at least two output modules comprising circuitry are arranged at a specified interval on at least two surfaces among the second surface, the third surface, the fourth surface, and the fifth surface.

2. The controller device of claim 1, wherein:
the second surface includes a first region and a second region;
the first region extending flatly in the first direction from at least a portion of the outer perimeter of the first surface; and
the second region curved from the first region toward the third surface.

3. The controller device of claim 1, wherein the third surface extends in the second direction from one side of the second surface and has a length shorter than a diameter of the first surface.

4. The controller device of claim 3, wherein, based on being extending in the second direction from one side of the second surface and having a length shorter than the diameter of the first surface, the third surface covers at least a portion of the first surface in a state of being spaced apart from the first surface.

5. The controller device of claim 1, wherein the at least two output modules include an LED output module comprising circuitry or an ultrasonic output module comprising circuitry.

6. The controller device of claim 1, further comprising:
a printed circuit board disposed inside the first housing; and
at least one processor, comprising processing circuitry, disposed on the printed circuit board.

7. The controller device of claim 6, further comprising a driving part, comprising circuitry,
wherein at least one processor, individually and/or collectively, is configured to control the driving part to cause the at least two output modules to output signals at a specified periodicity.

8. The controller device of claim 6, further comprising:
an input circuit; and
a sensor circuit,
wherein at least one processor, individually and/or collectively, is configured to cause the controller device to:
detect an input signal through the input circuit, and
obtain sensor data related to movement of the controller device through the sensor circuit.

9. The controller device of claim 8, further comprising a wireless communication circuit,
wherein at least one processor, individually and/or collectively, is configured to cause the controller device to transmit at least one of the input signal or the obtained sensor data through the wireless communication circuit (410) to a wearable electronic device (210).

10. The controller device of claim 1, wherein the third surface is capable of being removed.

11. The controller device of claim 1, wherein the third surface and the fourth surface are capable of being removed.

12. A wearable electronic device comprising:
a receive module comprising circuitry;
a camera; and
at least one processor, comprising processing circuitry, operably connected to the receive module and the camera,
wherein at least one processor, individually and/or collectively, is configured to cause the wearable electronic device \to:
receive signals output from a plurality of output modules of a controller device through the receive module;
identify a location of the controller device using the camera;
determine a distance to the controller device based on a signal received from the controller device;
generate a coordinate system for each of the wearable electronic device and the controller device using the distance and sensor data of each of the wearable electronic device and the controller device; and
track movement of the controller device based on the generated coordinate system for each of the wearable electronic device and the controller device.

13. The wearable electronic device of claim 12, wherein at least one processor, individually and/or collectively is configured to cause the wearable electronic device to receive signals output from the plurality of output modules of the controller device at a specified periodicity.

14. The wearable electronic device of claim 12, further comprising:
a wireless communication circuit; and
a sensor circuit,
wherein the sensor data of each of the wearable electronic device and the controller device includes first sensor data related to the movement of the wearable electronic device obtained through the sensor circuit, and second sensor data related to the movement of the controller device received from the controller device through the wireless communication circuit.

15. The wearable electronic device of claim 12, wherein at least one processor, individually and/or collectively, is configured to cause the wearable electronic device to: track, with respect to the coordinate system associated with a location of the wearable electronic device, the movement of the controller devices according to the coordinate system associated with a location of the controller devices.

16. The wearable electronic device of claim 12, further comprising a display,
wherein at least one processor, individually and/or collectively, is configured to cause the electronic device to perform functions related to content displayed on the display based on tracking the movement of the controller device.

17. A method for operating a wearable electronic device to track a controller device, the method comprising:
receiving signals output from a plurality of output modules of the controller device through a receive module;
identifying a location of the controller device using a camera;
determining a distance to the controller device based on signals received from the controller device;
generating a coordinate system for each of the wearable electronic device and the controller device using the distance and sensor data of each of the wearable electronic device and the controller device; and
tracking movement of the controller device based on the generated coordinate system for each of the wearable electronic device and the controller device.

18. The method of claim 17, wherein the receiving of the signals output from the plurality of output modules comprises receiving the signals output from the plurality of output modules of the controller device at a specified periodicity.

19. The method of claim 17, wherein the tracking of the movement of the controller device comprises tracking, with respect to the coordinate system associated with a location of the wearable electronic device, the movement of the controller devices according to the coordinate system associated with a location of the controller devices.

20. The method of claim 17, further comprising:
performing functions related to content displayed on the display based on tracking the movement of the controller device.
